(19) United States
(12) Patent Application Publication
(10) Pub. No.: US 2021/0340744 A1
(43) Pub. Date: Nov. 4, 2021

(54) SINK SPINNER

(71) Applicant: Bryan Alintoff, Middletown, NJ (US)

(72) Inventor: Bryan Alintoff, Middletown, NJ (US)

(21) Appl. No.: 17/071,815

(22) Filed: Oct. 15, 2020

Related U.S. Application Data
(60) Provisional application No. 63/019,494, filed on May 4, 2020.

(51) Int. Cl. E03C 1/04

(52) U.S. Cl. CPC E03C 1/0404; E03C 2001/0415; E03C 1/0401

(57) ABSTRACT

A basin rinsing device is adapted to be connected to plumbing fixture, such as a sink faucet. When the water is turned on, the water flows through the basin rinsing device. The water is able to pass through the basin rinsing device in one mode or cause the basin rinsing device to rotate and spray water in a second mode. The nozzles are angled so that that the sprayed water strikes the surface of a basin and facilitates removal of debris and dirt.

This application claims the benefit of U.S. Provisional Patent Application Ser. No. 63/019,494 filed May 4, 2020, the contents of which are hereby incorporated herein by reference.

### BACKGROUND

### 1. Field

This application is related to a rinsing device. In particular, the application is related to a rotating water flow control device for rinsing basins associated with plumbing fixtures.

### 2. Description of the Related Art

Sinks are a frequently used plumbing fixtures. Sinks and similar plumbing fixtures are found in kitchens, bathrooms, laundry rooms, and other locations. Sinks may have basins, faucets, drains, and other accessories.

A sink basin is generally an area, open on the top, that is adapted to receive water that then empties through a drain. The sink basin ultimately accumulates residue from a variety of activities such as shaving, teeth brushing, hand washing and dishwashing. Toothpaste, soap residue, hair, shaving cream, food residue, dirt, etc. often remains in the sink basin after these activities. Mineral residue from hard water also accumulates within sink basins.

Accumulated dirt and debris are difficult to remove from sink basins without effort. Water from the faucet typically does not reach all areas of a sink basin. Proper rinsing of sink typically requires additional effort through the use rinsing accessories.

U.S. Pat. No. 6,738,996 is directed to a pull-out spray head that permits a user to manually direct water to a desired location. However, the user has to grasp the spray head and manually direct the water to every spot. Further, the flow of water only covers a small portion of the surface of the basin.

Therefore, there remains a need for being able to automatically rinse and clean basins associated with plumbing fixtures.

### SUMMARY

Briefly described, aspects of the present disclosure relate to basin rinsing devices, in particular the present disclosure relates to a water enabled basin rinsing device.

An aspect of the present disclosure is a device for rinsing basins. The device for rinsing basins comprising: a connector adapted to connect the device to a plumbing fixture; a propulsion unit adapted to direct water passing through the device in at least two directions; and a housing for the propulsion unit having at least one nozzle adapted to direct water in a circumferential direction from the housing to a surface of a basin, wherein directing water in the circumferential direction rotates the housing.

Another aspect of the present disclosure is a device. The device comprising a propulsion unit adapted to direct water passing through the device in least two directions; and a housing for the propulsion unit having at least one nozzle adapted to direct water in a circumferential direction from the housing to a surface of a basin, wherein directing water in the circumferential direction rotates the housing.

### BRIEF DESCRIPTION OF THE DRAWINGS

FIG. 1 is an expanded 3D isometric exploded view of a basin rinsing device.

FIG. 2 is an expanded transparent 3D isometric exploded view of a basin rinsing device.

FIG. 3 are transparent and solid 3D isometric views of a water flu pin shown in FIGS. 1 and 2.

FIG. 4 are transparent and solid 3D isometric views of a propulsion unit shown in FIGS. 1 and 2.

FIG. 5 are transparent and solid 3D isometric view of a propulsion unit housing shown in FIGS. 1 and 2.

FIG. 6 is a 3D isometric view of an embodiment of a basin rinsing device.

FIG. 7 is a view of a valve portion of basin rinsing device shown in FIG. 6.

FIG. 8 is a front view of an embodiment of a basin rinsing device.

FIG. 9 is cross-sectional view of the basin rinsing device shown in FIG. 8 taken across the A-A section.

FIG. 10 is an exploded view of a propulsion unit.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art familiar with this disclosure.

The components described hereinafter as making up the various embodiments are intended to be illustrative and not restrictive. Many suitable components that would perform the same or a similar function as the components described herein are intended to be embraced within the scope of embodiments of the present disclosure.

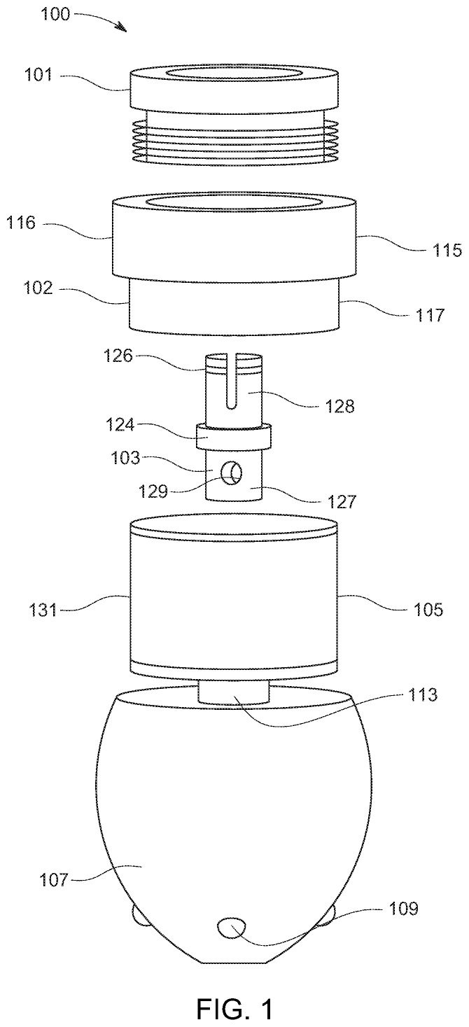

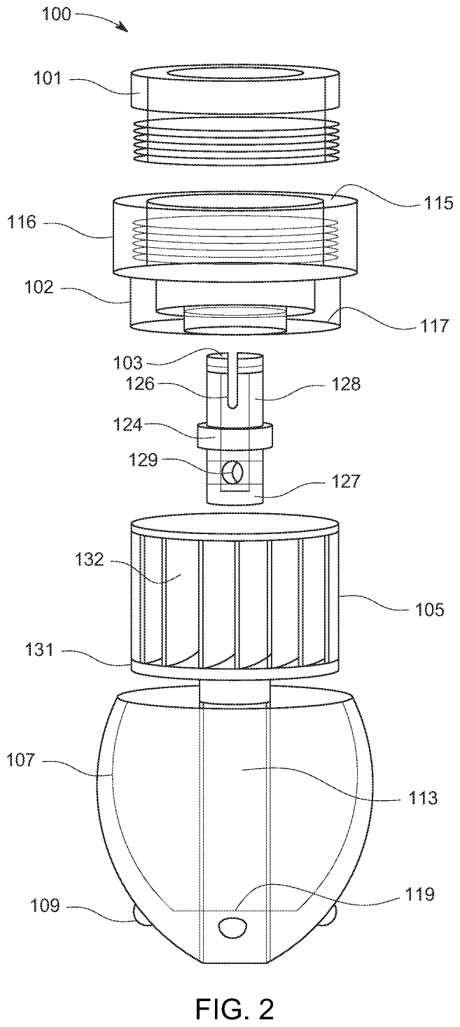

FIGS. 1 and 2 show two views of a basin rinsing device 100. FIG. 1 shows a solid 3-dimensional view of the basin rinsing device 100, while FIG. 2 shows a transparent 3-dimensional view of the basin rinsing device 100. The basin rinsing device 100 is adapted to be connected to a plumbing fixture via fixture connector 101. While in the foregoing figures reference is generally made to a sink and its faucet, in an embodiment, the basin rinsing device is adapted to be connected to other plumbing fixtures. In an embodiment, the basin rinsing device is adapted to be connected to a shower head. In an embodiment, the basin rinsing device is adapted to be connected to a toilet fixture, such as a bidet.

Returning to FIGS. 1 and 2, the basin rinsing device 100 is adapted to be connected to plumbing fixtures, such as faucets, that may come in all types of shapes and sizes. A faucet typically includes a spout and mechanism for turning water on and off. A faucet receives incoming water either from a cold-water pipe (or tube) or a hot water pipe (or tube) and diverts or directs the mixed water or the single stream of water to the faucet outlet. When a basin rinsing device 100 is connected to the faucet, the flow of water through the basin rinsing device 100 will cause the basin rinsing device 100 to activate. In an embodiment, the basin rinsing device is activated when the flow of water through the faucet is activated.

In an embodiment, the basin rinsing device is activated by a mechanism on the basin rinsing device itself. In an embodiment, the basin rinsing device is activated by a switch on the basin rinsing device. In an embodiment, the basin rinsing device is activated by a button on the basin rinsing device. In an embodiment, the basin rinsing device is activated by a touch sensor on the basin rinsing device. In an embodiment, the basin rinsing device is Wi-Fi enabled and is adapted to be activated remotely. In an embodiment, the basin rinsing device is Bluetooth® enabled and is adapted to be activated remotely.

Still referring to FIGS. 1 and 2, basin rinsing device 100 comprises a bearing seat 102, a water flu pin 103, a propulsion unit 105 and a propulsion unit housing 107. In an embodiment, the basin rinsing device 100 is adapted to be installed on a faucet by removing the faucet's aerator and attaching the basin rinsing device 100 to the end of the faucet with fixture connector 101.

As shown in FIGS. 1 and 2, the fixture connector 101 has an upper area with threads which engages with a threaded protrusion on a sink faucet, as well as a lower threaded protrusion which engages with a bearing seat 102. The basin rinsing device 100 can be installed or removed by screwing or unscrewing the bearing seat 102 from the fixture connector 101, or by unscrewing the fixture connector 101 from the faucet itself.

Currently there are more than one differently sized aerators in the American market that fixture connectors 101 are provided for. However, the fixture connector 101 may be modified and sized to connect to any faucet. Furthermore, while fixture connector 101 is discussed with respect to being screwed on and off of an aerator, other embodiments can attach a basin rinsing device to a plumbing fixture using other methods. In an embodiment, the fixture connector is a snap on device. In an embodiment, the fixture connector is an integral portion of a faucet or fixture. In an embodiment, the fixture connector is adapted to be clamped on a faucet or fixture. In an embodiment, the fixture connector is retained magnetically to a faucet or fixture.

Still referring to FIGS. 1 and 2, the bearing seat 102 comprises an outer race 115 adapted for retaining bearings. The outer race 115 permits the basin rinsing device 100 to rotate when activated. The upper part 116 of the bearing seat 102 has a threaded protrusion which engages with the threads of the lower portion of the fixture connector 101, while the lower part 117 of the bearing seat 102 has a ribbed protrusion which engaged with the threads of the water flu pin 103.

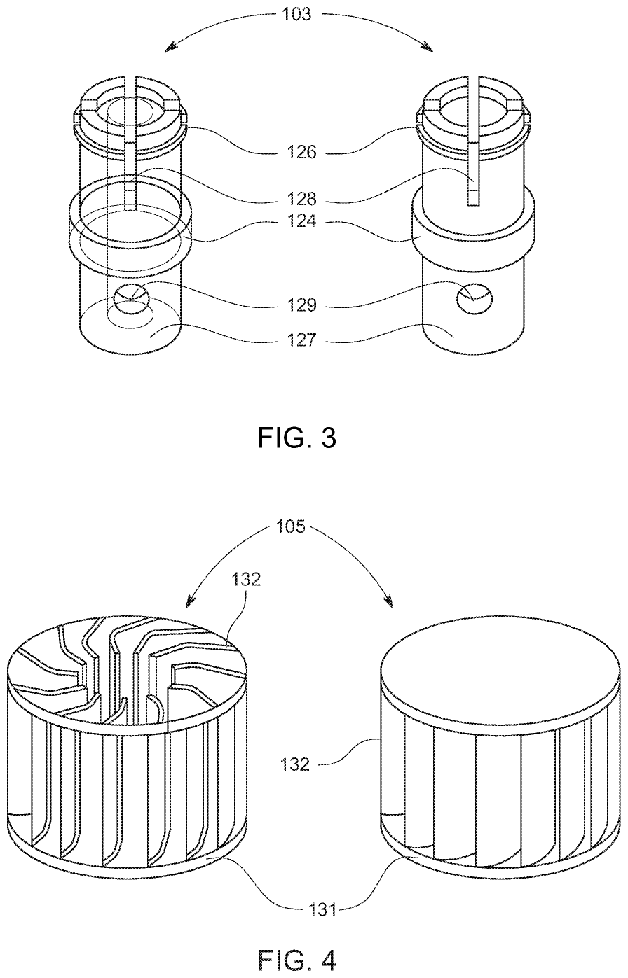

FIG. 3 illustrates the structure of the water flu pin 103. The upper portion 126 of the water flu pin 103 engages with the bearing seat 102 by forcefully inserting the upper portion 126 of the water flu pin 103 to the bearing seat 102. When the upper portion 126 is inserted into the bearing seat 102, the flanged portions 128 of the water flu pin 103 will compress towards each other. The compression of the flanged portions 128 will permit the flanged portions 128 to be inserted past the ribbed protrusion of the lower part 117 of the bearing seat 102.

The bottom portion 127 of the water flu pin 103 fits into the propulsion unit housing 107. In an embodiment, the water flu pin 103 has a plurality of holes 129 or other water paths on the bottom portion 127. In an embodiment, the holes are equally sized. In an embodiment, the holes are variably sized. In an embodiment, the “holes” are circular in shape. In an embodiment, the “holes” have another polygonal shape. In an embodiment, the “holes” are slats formed in the bottom portion.

A protruding ring 124 located in the middle of the water flu pin 103 prevents the propulsion unit housing 107 from pushing up further. The protruding ring 124 additionally correctly positions the water flu pin 103 with respect to the bearing seat 102 and the propulsion unit 105. Water is prevented from leaking from the water flu pin 103 by using elastomeric O-rings on both sides of the protruding ring 124. The O-rings are usually formed from rubber or equivalent material, which can be placed tightly against the end of a fixture, such as a faucet, with sufficient pressure to form a hydraulically tight connection. Therefore, when water is discharged through the faucet, the water will flow through the water flu pin 103 without leaking. In an embodiment, the water flu pin is directly connected to the propulsion unit 105 and formed as an integral unit with the propulsion unit.

Referring to FIG. 4, the propulsion unit 105 is formed as a water turbine, with a wheel 131 having curved blades 132. When the flowing water is directed towards the blades 132 of the propulsion unit 105, force is created which causes the curved blades 132 to move. This causes the propulsion unit housing 107 to rotate or spin.

Referring to FIGS. 1-5, the propulsion unit housing 107 houses the propulsion unit 105. The propulsion unit housing 107 is connected to the water flu pin 103 by inserting the bottom portion 127 of the water flu pin 103 to a tube 113 in the center of the propulsion unit housing 107. In an embodiment, tube 113 has the same number of holes as the number of holes 129 in the water flu pin 103.

The propulsion unit housing 107 has spray nozzles 109 circumferentially positioned along the outside surface of the propulsion unit housing 107. In an embodiment, there is one spray nozzle positioned on the outside surface. In an embodiment, there are two spray nozzles positioned on the outside surface. In an embodiment, there are three spray nozzles positioned on the outside surface. In an embodiment, there are four spray nozzles positioned on the outside surface. In an embodiment, there are five spray nozzles positioned on the outside surface. In an embodiment, there are six spray nozzles positioned on the outside surface. In an embodiment, there are seven spray nozzles positioned on the outside surface. In an embodiment, there are more than seven spray nozzles positioned on the outside surface. It should be understood that the number of spray nozzles can vary depending on the size and shape of the propulsion unit housing. Additionally, that while the spray nozzles may be equally spaced on the surface of the propulsion unit housing 107, the spacing may vary or there may be groupings of the spray nozzles.

In an embodiment, the propulsion unit housing 107 has an aerator located on the bottom of the propulsion unit housing 107 so the water can flow straight down, as in a normal faucet, when the basin rinsing device 100 is not activated.

In an embodiment, the basin rinsing device 100 is activated by twisting the propulsion unit housing 107. The twisting of the propulsion unit housing 107 causes the holes 119 in the tube 113 of the propulsion unit housing 107 to align with the holes 129 in the water flu pin 103 so that the water can flow through the holes 129 and into the propulsion unit 105.

When the flowing water is directed at the blades 132 of the propulsion unit 105, the water creates a force on the blades 132 so that the blades 132 of the propulsion unit will move in a circular direction (i.e. spin) thereby activating the basin rinsing device 100. The water flowing into the propulsion unit 105 changes direction upon impact upon the blades 132 and ultimately sprays from nozzles 109. The spray from the nozzles 109 will impact the surfaces of the basin. The spray removes dirt and debris.

A user of the basin rinsing device 100 can twist the propulsion unit housing 107 to let only portions of the holes 119 in the tube 113 align with the holes 129 in the water flu pin 103. The misalignment of holes reduces the water flow. Also, when a user twists the propulsion unit housing 107, the user may twist until the holes 119 in the tube 113 are not aligned with the holes 129 in the water flu pin 103. When the holes are not aligned, the water stops flowing into the propulsion unit 105, and the wheel 131 and blades 132 will stop spinning, thereby deactivating basin rinsing device 100.

In an embodiment, when the water flows through the nozzles 109 ceases, the water may be diverted and flow through an aerator located on the bottom of the propulsion unit housing 107. In an embodiment, a ring on the propulsion unit housing 107 selects different modes of operation. In an embodiment, a switch on the propulsion unit housing 107 selects different modes of operation. In an embodiment, a button on the propulsion unit housing 107 selects different modes of operation. The basin rinsing device 100 is deactivated when a selector is in off position. The basin rinsing device 100 is activated when the ring selector is in the on position.

In another embodiment, the basin rinsing device is activated by pulling down on the propulsion unit housing, causing the holes in the tube of the propulsion unit housing to align with the holes in the water flu pin. The alignment of the holes causes water to flow through the holes and into the propulsion unit. When the flowing water is directed to the blades of the propulsion unit, a force is applied to the blades thereby spinning the wheel and activating the basin rinsing device. The water flowing into the propulsion unit will change direction upon impact upon the rotary turbine and spray from the nozzles, rinsing the surface of the basin.

Similar to the manner in which turning the basin rinsing device and altering the alignment of the holes impacted the spray from the basin rinsing device. In the pulling and pushing embodiment, the user can push up the propulsion unit housing to let only portions of the holes in the tube match the holes in the water flu, thereby reducing water flow. The user can further push up the propulsion unit housing until the protruding ring of the water flu pin is hit. When the holes in the tube misalign with the holes in the water flu pin completely, the water stops flowing into the propulsion unit, and the wheel stops spinning, thereby deactivating the basin rinsing device.

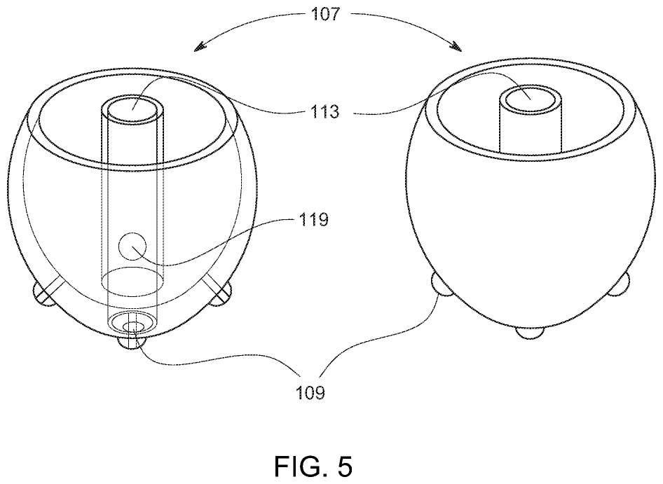

Referring back to FIG. 5, spray nozzles 109 are designed to spray water into a basin at different angles to cover as much of the surface of the basin as possible. The angle of the spray nozzles 109 are adjustable to fit basins of different sizes and shapes. The spray nozzles 109 are able to adjust vertically and horizontally with respect to the surface of a basin. In an embodiment, each spray nozzle is adjustable in a different direction. In an embodiment, only some of the spray nozzles are adjustable. In an embodiment, the spray nozzles are only adjustable horizontally with respect to a surface of the basin. In an embodiment, the spray nozzles are adjustable to move at an angle with respect to the surface of the basin. In an embodiment, the spray nozzles are immobile, requiring the purchase of a different unit customized for different basins. In an embodiment, the sprayed water hits the surface of the basin from multiple angles, quickly breaking down the dirt and grime on the surface of the basin and rinsing the basin thoroughly.

In an adjustable basin rinsing device, the first time the basin rinsing device 100 is attached to a faucet, the user can simply pull down or twist the propulsion unit housing 107 and adjust the heights and angles of the nozzles 109 so that the sprayed water from the nozzles 109 can cover the entire surface of the basin. The user may adjust the nozzles 109 as needed.

Additionally, the basin rinsing device 100 use may slow or reduce the amount of water that flows through a faucet. This can reduce a user's water bill.

The basin rinsing device 100 can be also placed on a touchless or automatic faucet. The sensor of the touchless or automatic faucet may sense the presence of a user and operate the electrically operated valve to provide a flow of water. When it no longer detects the presence of a user's hands for few seconds, the propulsion unit housing 107 can be pulled down or twisted automatically by a mechanism and the propulsion unit 101 can begin to spin and spray water from the nozzles 109 to rinse the sink basin.

After a pre-determined time, the propulsion unit housing 107 can retract or twist automatically to let the holes 119 in the tube 113 misalign with the holes 129 in the water flu pin 103 completely, thus stopping water flowing into the propulsion unit 105 and stopping the wheel 131. The valve then shuts off automatically.

In an embodiment, the basin rinsing device 100 may also include an aperture on a portion of the propulsion unit housing 107 to let the user fill a reservoir with all-purpose cleaner, dish soap or other kind of cleaner to mix up with the tap water to facilitate rinsing of a basin.

The basin rinsing device 100 may be comprised of any suitable material, such as, for example, metal, plastic, resin, polymer, ceramic or combinations thereof.

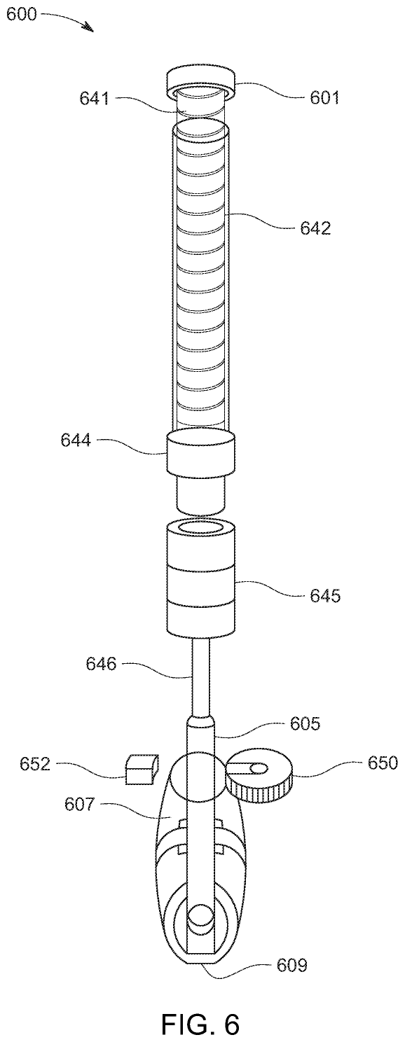

Turning to FIGS. 6-8, another embodiment of a basin rinsing device is shown. Basin rinsing device 600 has a fixture connector 601. The basin rinsing device 600 comprises a fixture connector 601, a male telescoping component 641, a female telescoping component 642, a valve connector 644, a valve 645, a pipe 646, a propulsion unit 605, a female selector switch 650, a male selector switch 652, and a propulsion unit housing 607. The basin rinsing device 600 can be installed on a faucet by removing the faucet's current aerator and attaching the basin rinsing device 600 to the end of the faucet.

As shown in FIG. 6, the fixture connector 601 has a threaded protrusion at the inner wall which engages with the male telescoping component 641. The male telescoping component 641 has a hole in the center to let the water from the faucet flows through the male telescoping component 641. The outside wall of the male telescoping component 641 has a ribbed protrusion which can be fastened onto the fixture connector 601 and thus engaged with a threaded protrusion on the faucet. The basin rinsing device 600 can be easily installed or removed by screwing or unscrewing the male telescoping component 641 from the fixture connector 601.

The female telescoping component 642 houses and retains the male telescoping component 641. Together, the male telescoping component 641 and female telescoping component 642 provide movement in a vertical direction with respect to a surface of the basin.

The valve connector 644 connects to the female telescoping component 642. The valve connector 644 has a recess formed on the top portion with a hole in the center that connects to the female telescoping component 642. The lower portion of the valve connector 644 has a ribbed protrusion which can be engaged with the threads of the valve 645. Water can flow through the central hole in the valve connector 644. The valve connector 644 allows for adjustment in the vertical direction with respect to a basin. Valve 645 has a cone shaped seat with a hole in the center that valve connector 644 is adapted to screw into.

Valve 645 has threaded protrusion on the inner wall of the top portion and engages with the lower portion of the valve connector 644. The valve 645 resembles a water turbine or wheel with curved blades in the middle portion and functions similarly to propulsion unit 105 discussed above. When the valve connector 644 is unscrewed from the valve 645, the water passed through the valve connector 644 will flow into the spaces between the outer wall of the cone shaped seat and the inner wall of the valve 645, and change direction upon impact on the blades of the turbine, which creates a force on the blades so that the wheel will spin, thus the valve 645 is activated in spin mode.

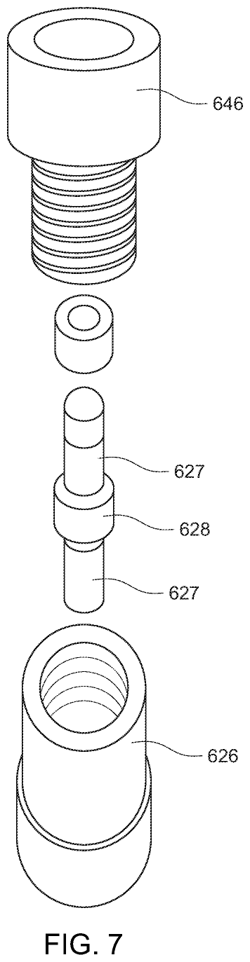

Referring to FIG. 7, the upper part of the pipe 646 has threaded protrusion and engages with the valve 645 and the bottom part of pipe 646 slides into the propulsion unit 605 and connects with the propulsion unit housing 607 via a bearing seat 626.

When the lower portion of the valve connector 644 is screwed into the threads of the valve 645, the valve 645 is in aerator mode and water from the faucet flows through the male telescoping component 641 and passes through the hole of the valve connector 644. The water then enters the pipe 646 attached to the valve 645 and flows out from the aerator on the bottom of the propulsion unit housing 614. Water is prevented from leaking out of the pipe 646 by means of elastomeric O-rings 627 on both sides of an inner bearing seat 628. The O-rings are usually of rubber or equivalent material, which can be attached tightly with sufficient pressure to form a hydraulically tight connection. Therefore, when the valve 645 is in aerator mode and the water is discharged through the faucet. The water will flow through the pipe 646 without leaking.

The propulsion unit 605 has threaded protrusion that can be screwed to the threaded protrusion inside the valve 645. When the valve 645 is placed in aerator mode, the propulsion unit 605 is bypassed and the water flows through the pipe 646 and out from the aerator on the bottom of the propulsion unit housing 607.

The female selector switch 650 is in C-shape and can be fit into the outer wall of the top portion of the propulsion unit 605. The male selector switch 652 has a protrusion on both sides that can slide into the groove of the female selector switch 650. The male selector switch 652 and the female selector switch 650 can be placed on the outer wall of the top portion of the propulsion unit 605. When the male selector switch 652 slides into the female selector switch 650, they can be used as a “handle” to twist the propulsion unit 605 to let the propulsion unit 605 unscrew from the valve 645, permitting water flow between the propulsion unit 605 and the propulsion unit housing 607 instead of flowing through the aerator.

When the valve connector 644 is unscrewed from the valve 645, the valve 645 is in spin mode and water that passes through the hole of the valve connector 644 will be directed onto the blades of the valve 645.

The flowing water will change direction upon impact upon the blades of the valve 645 and flow into the space between the propulsion unit 605 and the propulsion unit housing 607, then spray from the nozzles 609 located on the outer surface of the propulsion unit housing 607. This cleans the surface of the basin.

Referring to FIGS. 6-7, the propulsion unit housing 607 receives the propulsion unit 605 and is connected to the pipe 646 by inserting the bottom part of the pipe 646 to a bearing seat 626 in the bottom center of the propulsion unit housing 607. Spray nozzles 609 are circumferentially positioned along the outside surface of the propulsion unit housing 607. Spray nozzle arrangements and embodiments can occur in the same manner as those discussed above with respect to FIGS. 1-5.

The propulsion unit housing 607 has an aerator located on the bottom so that water can flow straight down, as in a normal faucet, when the valve 645 is in aerator mode. The water entering into the pipe 646 may flow out from the holes on the propulsion unit 605 and thus spray out of the nozzles 609 of the propulsion unit housing 607.

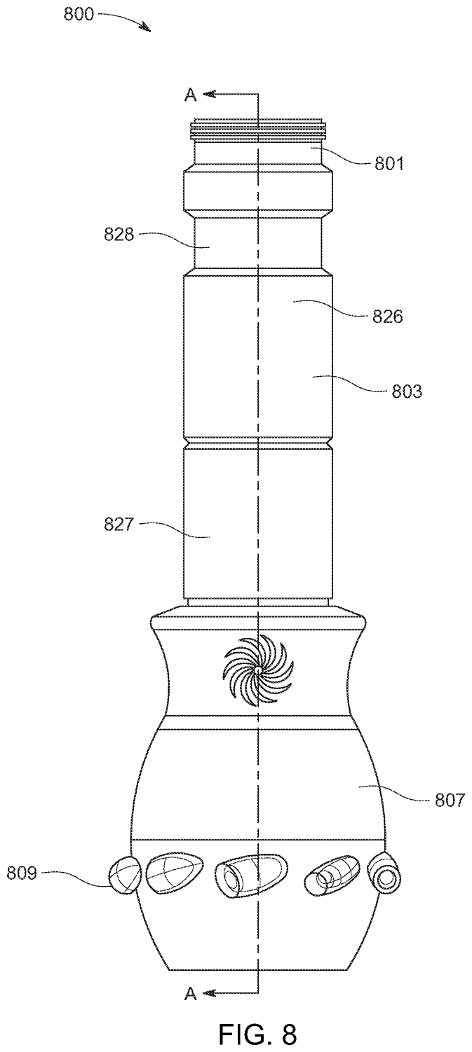

FIG. 8 shows basin rinsing device 800. Basin rinsing device 800 comprises an extending unit 803, a propulsion unit 805 and a propulsion unit housing 807. In an embodiment, the basin rinsing device 800 is adapted to be installed on a faucet by removing the faucet's aerator and attaching the basin rinsing device 800 to the end of the faucet with a fixture connector 801.

As shown in FIG. 8, the fixture connector 801 has an upper area with threads which engages with a threaded protrusion on the sink faucet, as well as a lower threaded protrusion which engages with an extending unit 803. The basin rinsing device 800 can be easily installed or removed by screwing or unscrewing the extending unit from the fixture connector 801, or by unscrewing the fixture connector 801 from the faucet itself.

Fixture connector 801 may be modified and sized to connect to any faucet. Furthermore, while fixture connector 801 is discussed with respect to be being screwed on and off of an aerator, other embodiments can attach the basin rinsing device using other methods. In an embodiment, the fixture connector is a snap on device. In an embodiment, the fixture connector is an integral portion of the faucet or fixture. In an embodiment, the fixture connector is a clamp on device. In an embodiment, the fixture connector is retained magnetically.

The extending unit 803 is movable vertically up and down with respect to a basin. The upper portion 826 and lower portion 827 of the extending unit 803 moves vertically up and down over an upper surface area 828 of the extending unit 803. The extending unit 803 is movable by a user by grasping the propulsion unit housing 807 and moving the extending unit 803 in a vertically up or down direction to switch the basin rinsing device 800 from mode where the water passes through the basin rinsing device 800 to the mode where the water is forced from the spray nozzles 809 and rotates the propulsion unit housing 807.

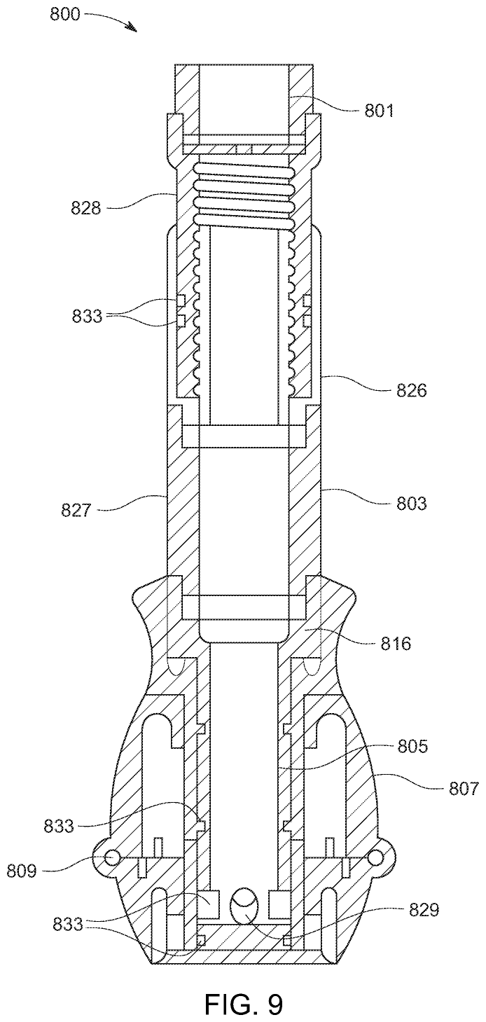

FIG. 9 shows a cross-sectional view of the basin rinsing device 800 taken along the section A-A. In FIG. 9, the interior of the propulsion unit 805 comprising the valve 816 is shown. Located along the valve are O-rings 833 adapted to seal portions of the interior of the propulsion unit 805 when the valve 816 is moved via the movement of the valve 816 through the operation of the extending unit 816. Movement of the valve 816 within the propulsion unit 805 will permit water to pass through the propulsion holes 829. Water passing through the propulsion holes 829 causes water to pass through the spray nozzles 809. The angling of the spray nozzles 809 causes the propulsion unit housing 807 to rotate and spray water throughout a basin.

In an embodiment, the propulsion holes are equally sized. In an embodiment, the propulsion holes are variably sized. In an embodiment, the “holes” are circular in shape. In an embodiment, the “holes” have another polygonal shape. In an embodiment, the “holes” are slats formed in the bottom portion.

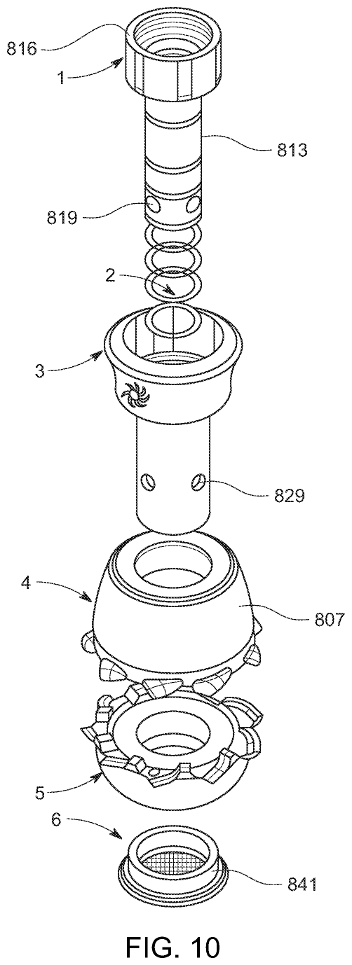

Referring to FIG. 10, shown is isometric 3-D expanded view of the propulsion unit 805. The valve 816 has an extended tube 813 on which 0-rings 833 are located. Further located within the valve 816 are valve holes 819. During movement of the propulsion unit 805 the valve 816 moves within the propulsion unit and aligns the valve holes 819 with the propulsion holes 829. The alignment of the valve holes 819 and the propulsion holes 829 permits water to pass through the spray nozzles 809. Similar to the propulsion holes 829, valve holes 819 can have various configurations and are generally complementary to the propulsion holes 829.

When the valve holes 819 and the propulsion holes 829 are not aligned the water passes through the aerator 841. When the water passes through the aerator 841 the propulsion unit housing 807 will not rotate.

In an embodiment, the propulsion unit housing 807 has spray nozzles 809 circumferentially positioned along the outside surface of the propulsion unit housing 807. In an embodiment, there is one spray nozzle positioned on the outside surface. In an embodiment, there are two spray nozzles positioned on the outside surface. In an embodiment, there are three spray nozzles positioned on the outside surface. In an embodiment, there are four spray nozzles positioned on the outside surface. In an embodiment, there are five spray nozzles positioned on the outside surface. In an embodiment, there are six spray nozzles positioned on the outside surface. In an embodiment, there are seven spray nozzles positioned on the outside surface. In an embodiment, there are more than seven spray nozzles positioned on the outside surface. It should be understood that the number of spray nozzles can vary depending on the size and shape of the propulsion unit housing. Additionally, the while the spray nozzles may be equally spaced on the surface of the propulsion unit housing 807, the spacing may vary or there may be groupings of the spray nozzles.

In an embodiment, a user of the basin rinsing device 800 can adjust the propulsion unit housing 807 to let only portions of the valve holes 819 align with the propulsion holes 829. The misalignment of holes reduces the water flow.

In an embodiment, a ring on the propulsion unit housing 807 selects different modes of operation. In an embodiment, a switch on the propulsion unit housing 807 selects different modes of operation. In an embodiment, a button on the propulsion unit housing 807 selects different modes of operation. The basin rinsing device 800 is deactivated when a selector is in off position. The basin rinsing device 800 is activated when the ring selector is in the on position.

Referring back to FIGS. 8-10, nozzles 809 are designed to spray water into a basin at different angles to cover as much of the surface of the basin as possible. In an embodiment the spray nozzles are angled so that water expelling from the nozzles is expelled tangential to the circumference of the propulsion unit housing 807. The angle of the nozzles 809 are adjustable to fit basins of different sizes and shapes. The spray nozzles 809 are able to adjust vertically and horizontally with respect to the surface of a basin. In an embodiment, each spray nozzle is adjustable in a different direction. In an embodiment, only some of the spray nozzles are adjustable. In an embodiment, the spray nozzles are only adjustable horizontally with respect to a surface of the basin. In an embodiment, the spray nozzles are adjustable to move at an angle with respect to the surface of the basin. In an embodiment, the spray nozzles are immobile, requiring the purchase of a different unit customized for different basins. In an embodiment, the sprayed water hits the surface of the basin from multiple angles, quickly breaking down the dirt and grime on the surface of the basin and rinsing the basin thoroughly.

Additionally, the basin rinsing device 800 use may slow or reduce the amount of water that flows through a faucet. This can reduce a user's water bill.

The basin rinsing device 800 can be also placed on a touchless or automatic faucet. The sensor of the touchless or automatic faucet may sense the presence of a user and operate the electrically operated valve to provide a flow of water. When it no longer detects the presence of a user's hands for few seconds, the propulsion unit housing 807 can be pulled down automatically by a mechanism and the propulsion unit housing 807 begin to spin and spray water from the nozzles 809 to rinse the sink basin.

After a pre-determined time, the propulsion unit housing 807 can retract automatically to let the basin rinsing device 800 cease rotating.

In an embodiment, the basin rinsing device 800 may also include an aperture on a portion of the propulsion unit housing 807 to let the user fill a reservoir with all-purpose cleaner, dish soap or other kinds of cleaner to mix up with the tap water to facilitate rinsing of a basin.

The basin rinsing device 800 may be comprised of any suitable material, e.g., metal, plastic, resin, polymer, ceramic or combinations thereof.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A device for rinsing basins comprising:
a connector adapted to connect the device to a plumbing fixture;
a propulsion unit adapted to direct water passing through the device in at least two directions; and
a housing for the propulsion unit having at least one nozzle adapted to direct water in a circumferential direction from the housing to a surface of a basin, wherein directing water in the circumferential direction rotates the housing.

2. The device for rinsing basins of claim 1, comprising a wheel having a plurality of curved blades adapted to rotate the wheel when water strikes a surface of at least one of the curved blades.

3. The device for rinsing basins of claim 1, further comprising a bearing seat operably connected to the propulsion unit.

4. The device for rinsing basins of claim 1, wherein a direction that the at least one nozzle is directed to when the device is connected to the plumbing fixture is adjustable.

5. The device for rinsing basins of claim 1, wherein the at least one nozzle is one of a plurality of nozzles.

6. The device for rinsing basins of claim 1, wherein pulling of the device in a direction towards the surface of the basin changes alignment of holes through which the water flows.

7. The device for rinsing basins of claim 1, wherein twisting of the device in a circumferentially horizontal direction with respect to the surface of the basin changes alignment of holes through which the water flows.

8. The device for rinsing basins of claim 1, wherein the device is adapted to permit water to flow through without passing through the at least one nozzle.

9. The device for rinsing basins of claim 1, wherein the at least one nozzle is one of a plurality of nozzles and each of the plurality of nozzles is equidistantly spaced from each adjacent nozzle.

10. The device for rinsing basins of claim 1, wherein the at least one nozzle is adapted to rotate around an axis passing through a center of the device.

11. A device comprising:
a propulsion unit adapted to direct water passing through the device in at least two directions; and
a housing for the propulsion unit having at least one nozzle adapted to direct water in a circumferential direction from the housing to a surface of a basin, wherein directing water in the circumferential direction rotates the housing.

12. The device of claim 11, wherein the propulsion unit comprises a plurality of blades arranged in a substantially circular arrangement adapted to rotate when water strikes a surface of at least one of the plurality of blades.

13. The device of claim 11, further comprising a bearing seat operably connected to the propulsion unit.

14. The device of claim 11, wherein a direction of any of the plurality of nozzles when the device is connected to a plumbing fixture is adjustable.

15. The device of claim 11, wherein the device is adapted to be connected to more than one type of plumbing fixture.

16. The device of claim 11, wherein pulling of the device in a direction towards the surface of a basin changes alignment of holes through which the water flows.

17. The device of claim 11, wherein twisting of the device in a circumferentially horizontal direction with respect to the surface of a basin changes alignment of holes through which the water flows.

18. The device of claim 11, wherein the device is adapted to permit water to flow through without passing through any of the plurality of nozzles.

19. The device of claim 11, wherein each of the plurality of nozzles is equidistantly spaced from each other adjacent one of the plurality of nozzles.

20. The device of claim 11, wherein the at least one of the plurality of nozzles is adapted to rotate around an axis passing through a center of the device.
